(19) United States
(12) Patent Application Publication
(10) Pub. No.: US 2024/0145843 A1
(43) Pub. Date: May 2, 2024

(54) COMPRESSION PAD WITH SHAPE MEMORY FUNCTION AND ASSOCIATED MANUFACTURING METHOD

(71) Applicant: Dr. Ing. h.c. F. Porsche Aktiengesellschaft, Stuttgart (DE)

(72) Inventor: Dominik Grass, Bietigheim-Bissingen (DE)

(73) Assignee: Dr. Ing. h.c. F. Porsche Aktiengesellschaft, Stuttgart (DE)

(21) Appl. No.: 18/474,446

(22) Filed: Sep. 26, 2023

(30) Foreign Application Priority Data
Nov. 2, 2022 (DE) 10 2022 128 911.7

(51) Int. Cl. H01M 50/291; H01M 10/613; H01M 10/615; H01M 10/647; H01M 10/6557; H01M 50/211; H01M 50/293

(52) U.S. Cl. CPC H01M 50/291; H01M 10/613; H01M 10/615; H01M 10/647; H01M 10/6557; H01M 50/211; H01M 50/293; H01M 10/0481

(57) ABSTRACT

A compression pad having a shape memory function for a battery cell stack. The pad includes an internal space in which a filler material is present, wherein the internal space is additionally filled with a medium or the medium is machined into the filler material. Due to its strength, the medium holds the compression pad in a compressed shape compared to a shape that the compression pad would take without the medium. Further, there are described methods for manufacturing a compression pad with a shape memory function as well as for manufacturing a battery cell module.

### CROSS-REFERENCE TO RELATED APPLICATION

This application claims priority to German Patent Application No. 10 2022 128 911.7, filed Nov. 2, 2022, the content of such application being incorporated by reference herein in its entirety.

### FIELD OF THE INVENTION

The present invention relates to a compression pad having a shape memory function, in particular for use in a battery cell stack (battery cell packet). Furthermore, the invention relates to a method of manufacture for such a compression pad as well as additionally for a battery cell stack having compression pads with the shape memory function.

### BACKGROUND OF THE INVENTION

The range of electric vehicles is largely determined by the traction battery installed therein. Today, appropriately sized high-voltage batteries are used in order to propel modern electric vehicles, which are made up of battery cell modules (also referred to as battery modules), each of which in turn contains a number of battery cells, each representing the smallest self-contained energy storage cell. For example, the two-ply performance battery plus used in some models of the Porsche Taycan comprises 33 cell modules, each consisting of twelve individual battery cells. The traction battery thus comprises a total of 396 battery cells, wherein lithium-ion accumulators are used as the battery cells. The traction battery has a system voltage of 800 volts and a total capacity of 93.4 kWh.

In general, in order to construct the batteries, battery modules are used in which multiple cells are arranged in parallel, wherein a compression pad (also referred to as a compression insert) is respectively arranged between two cells. The compression pads arranged between the battery cells perform a further important task, namely providing an equilibrium for the growing cell thicknesses (swelling). Swelling is a volume change of a battery cell, in particular a lithium ion cell, which can be observed on the one hand during charging and discharging and on the other hand on a slower time scale due to the aging of the battery cell. Swelling is caused by a structural change of the active layers within the battery cell caused by the rearrangement of lithium ions occurring therein. Swelling is particularly pronounced in the case of pouch cells, a widely used design for battery cells. By placing compression pads between the battery cells in the stacking direction as described above, they can compressively compensate for the volume change of the battery cells within a battery module.

In addition, by means of the compressible pads, forces can be built up in the battery cell package, which can cause it to strain in the housing (battery or module housing). In order to achieve a good pre-loading, the external dimensions of the battery cell package usually differ only marginally from the internal dimensions of the housing. Currently, pure foam pads, which can be highly compressed, are used as the compression pads. Thus, during installation, the battery cell packet is superimposed in order to temporarily reduce its dimensions and, in this superimposed state, is pushed into the housing, which makes the operation of sliding the battery cell stack complicated and thereby makes it relatively complex on the process side. The insertion process then takes place under certain insertion forces, because the battery cell packet presses against the inside of the housing when inserted from the inside, and thus friction forces occur, which, under certain circumstances, can damage either the battery cells or the compression pads.

US 2014/141307A1, which is incorporated by reference herein, discloses a battery having a battery case and multiple battery cells arranged adjacent to one another, wherein a foam compression pad is arranged between two adjacent battery cells, which is compressed during the assembly process and expanded after assembly.

EP3893291A1, which is incorporated by reference herein, discloses a battery having multiple battery cells and multiple compression and heat protection pads arranged between two adjacent battery cells, wherein the compression pads shrink as the temperature increases.

A battery cell packet is known from EP2475040A1, which is incorporated by reference herein, multiple battery cells are pressed between two terminating elements, and wherein a pressure pad is arranged between the terminating elements and the battery cells.

### SUMMARY OF THE INVENTION

Proceeding from the compression pads and assembly methods of battery cell stacks in housings known from the prior art, the problem addressed by the present invention can be seen as providing compression pads as well as a corresponding manufacturing method that facilitates the assembly process.

The present invention is based on a compression of the compression pads to a defined extent that occurs in advance of the formation of the battery cell stack. This extent of compression is fixed by the retaining force of an additional medium or material and, in particular, maintained during the formation of the battery cell stack and its assembly in the housing. The defined extent of the compressed compression pads is selected such that the formed battery cell stack is undersized with respect to the design space provided for this purpose in the housing and can thus be inserted more easily into the housing. Later, the compression pad expands or unfolds in the housing and builds up the desired compression forces on the battery cells in order to fix them in place in the housing.

Stabilizing or “freezing” the compressed state of the compression pad is achieved by filling or soaking the compression pad with a medium or by incorporating the medium as an additive into the filler material of the compression pad. In the first case, the medium can be the cooling medium of a liquid cooling system of a battery, in particular a direct cooling battery, in which the battery modules are directly perfused by the cooling medium inside the housing. This medium becomes hard or very tough at a certain temperature, which is below the operating temperature of the battery cell stack during its intended use in a battery. At higher temperatures, and especially at a temperature in the range of the operating temperature of the battery cell stack, on the other hand, the medium is soft or liquid. In other words, at this temperature, its strength is less.

In order to provide the compression pad with a shape memory function, it is pressed together with the medium to a predetermined, e.g. a minimum thickness, and cooled down in this state such that the medium, which thereby hardens or toughens, holds the compression pad in this state. In this state, which has been compressed in a self-sustaining manner, i.e. without further external forces, the compression pad is installed in the battery cell stack. As a result, the battery cell stack is undersized and can be inserted into a battery module or battery housing more easily, in particular without a tool that builds up pressure on the battery cell stack.

In this case, the required temperature stroke can be carried out, depending on the medium selected, either from a temperature above room temperature (for example, a temperature in the range of the operating temperature of the battery cell stack) to room temperature or to a lower temperature, or also from a temperature in the range of the room temperature to a temperature below the room temperature.

The shape memory function of the compression pads according to aspects of the invention is carried when there is heating of the compression pads, which have been stabilized in the compressed state by the medium, to a temperature at which the medium softens or liquefies and its retaining force decreases. From a certain temperature, the expansion forces of the filler material in the compression pad become greater, causing it to expand again according to its shape memory. The expanding compression pads compress the battery cells in the battery module or battery housing, thereby completing the assembly step.

The operating mechanism of the present invention can be illustrated on the basis of a sponge as a compression pad and water as a medium. To manufacture a sponge with a shape memory function, it is first filled/saturated with water, compressed, and frozen. After completion of the freezing process, the compressed sponge is held in its shape for as long as the water frozen in the sponge is thin. The frozen sponge is then pushed into a housing to its installation location. Because the sponge is undersized, its insertion into the housing is easy and, to the left and right of the sponge, there is a gap relative to the inner wall of the housing. The sponge thaws due to the higher ambient room temperature and attempts to restore its original shape. It thereby expands and presses from the inside to the inner walls of the housing.

According to aspects of the invention, there is first provided a compression pad having a shape memory function for a battery cell stack, comprising an internal space in which a filler material is present, wherein the internal space is additionally filled with a medium or the medium is machined into the filler material, wherein, due to its strength, the medium holds the compression pad in a compressed shape compared to a shape that the compression pad would take without the medium. The state of the compression pad described herein consequently corresponds to the compressed state, which is fixed by means of the medium which has been cooled down, so to speak.

According to further embodiments of the compression pad, the filler material can be elastic. For example, the filler material can comprise a plastic, such as a foamed plastic.

According to further embodiments of the compression pad, the medium can comprise a cooling medium of a liquid cooling system of a battery. The cooling medium can be an electrically non-conductive liquid with properties otherwise suitable for a cooling medium (heat capacity, viscosity, flash point). When using a cooling medium as the medium, it can be expediently the same cooling medium used in the electric vehicle in the cooling system, because it is released from the filler material into its environment and thus into the cooling medium of the battery after installation and later compression. As a result, undesirable contamination of the cooling medium circulating in the cooling circuit of the electric vehicle by other liquids can be avoided, which can occur, for example, if a cooling medium deviating therefrom were to be present in an interior space of the compression pad.

According to aspects of the invention, there is further provided a method for manufacturing a compression pad with a shape memory function for a battery cell stack. The method first comprises the insertion of a medium into a compression pad. The insertion of the medium can comprise a filling of the medium into the compression pad or soaking of the compression pad with the medium. Alternatively, the step can also comprise an incorporation of the medium in the form of an additive into the compression pad, for example in its filler material.

In a next step, the manufacturing method according to aspects of the invention comprises compression of the compression pad filled with the medium. The compression pad is brought to a target size, for example in terms of its expansion along the stacking direction of battery cells in the battery cell stack.

In a further step, the method according to aspects of the invention comprises a cooling of the compressed compression pad to a temperature which causes the cooled medium to be able to hold the compression pad in its compressed shape when no external forces are acting thereupon. In other words, the cooling of the medium located in the compression pad results in a change in its material properties towards an increased retaining force. The medium can become so hard or tough that its retaining force exceeds the expansion force of the filler material of the compression pad, whereby it remains in the compressed shape.

The medium can also be used as a cold storage device, allowing the compression pad to warm up more slowly, thus extending the time until the compression pad expands. For example, a compression pad can become compressed and frozen, but, due to the low thermal mass, can rapidly warm up and expand through the ambient temperature before it can be installed in end positions. If this compression pad is now pre-saturated in a cooling medium, its thermal mass can thus be increased. Again, this can increase the time until the compression pad heats up and expands.

According to further embodiments of the manufacturing method according to aspects of the invention, the medium can comprise a cooling medium of a liquid cooling system of a battery.

According to further embodiments of the manufacturing method according to aspects of the invention, the medium can be an additive incorporated into the interior of the compression pad. The additive can thus be incorporated in the manufacture of the filler material of the compression pads or the compression pads themselves.

According to further embodiments of the manufacturing method according to aspects of the invention, the temperature at which the compression pad is cooled can be below an operating temperature of the battery cell stack.

According to aspects of the invention, there is further provided a method for manufacturing a battery cell module based on a battery cell stack in which the compression pads according to aspects of the invention are installed. The method initially comprises providing a battery cell packet with an arrangement of battery cells, wherein a respective compression pad is arranged between two battery cells, which has been produced according to an embodiment of the previously described method for manufacturing a compression pad according to aspects of the invention.

The method further comprises inserting the battery cell package into a housing, wherein the battery cell package is undersized with respect to the design space provided for it in the housing.

According to further embodiments of the manufacturing method according to aspects of the invention, the method can further comprise heating the compression pads to a temperature that causes the medium to be no longer capable of holding the compression pad in its compressed shape. In other words, the method according to aspects of the invention can comprise the expansion of the compression pads by supplying heat, thereby reducing the strength of the medium.

According to further embodiments of the manufacturing method according to aspects of the invention, the heating of the compression pads can be caused by means of a fluid (liquid or gas) flowing through the battery cell module. For example, when the battery cells are assembled in the battery cell module, this can occur by means of warm air which is passed through the battery cell module.

It goes without saying that the aforementioned features and the features yet to be explained in the following can be used not only in the respectively specified combination, but also in other combinations or on their own, without leaving the scope of the present invention.

### BRIEF DESCRIPTION OF THE DRAWINGS

Additional advantages and configurations of the invention result from the description and the enclosed drawings.

FIGS. 1A-1C illustrate an embodiment example of the method according to aspects of the invention for manufacturing a compression pad with a shape memory function.

FIGS. 2A-2C illustrate an embodiment example of the method according to aspects of the invention for manufacturing a battery cell module.

### DETAILED DESCRIPTION OF THE INVENTION

The method for manufacturing a compression pad with a shape memory function begins with providing a suitable compression pad 1. In this pad, either a medium 2, which provides a retaining force in a later phase of the method, is already incorporated or the compression pad 1 is filled or saturated with this medium 2.

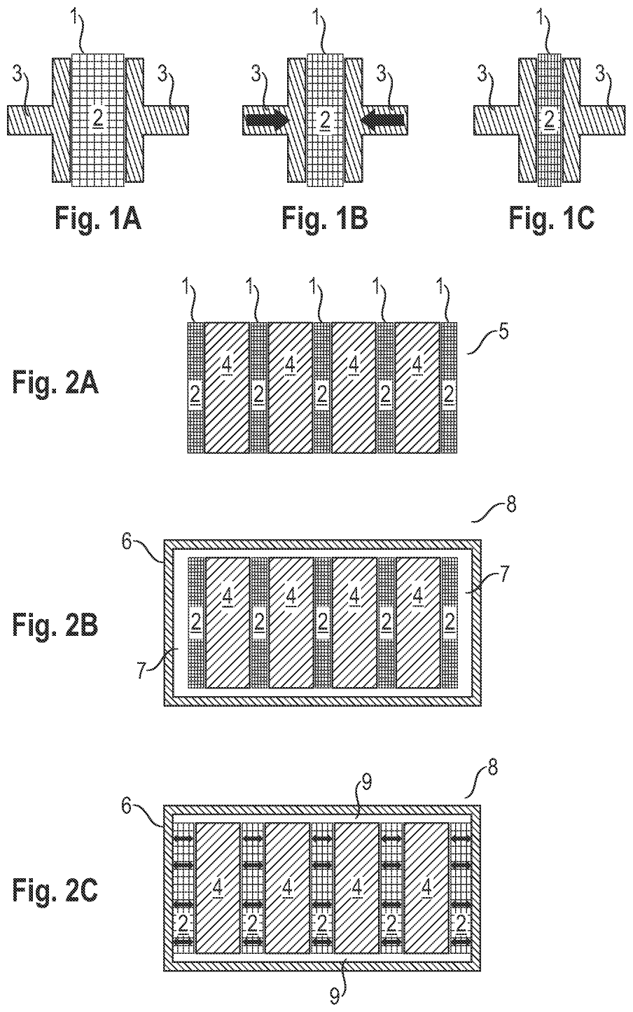

In FIG. 1A, the start of the compression is shown. For this purpose, the compression pad 1 comprising the medium 2 can be arranged between two presser arms 3 of a press. In FIG. 1B, a compression of the compression pad 1 to a desired extent is performed. In FIG. 1C, there is a temperature drop while the compression pad 1 remains in a compressed state. The heat depletion changes the material properties of the medium 2, so that it becomes tougher or firmer and exerts a retaining force that counteracts the expansion force of the compression pad 1 in relation to its original dimensions (FIG. 1A) and exceeds it from a certain temperature. When a stable condition is achieved, in which the compression pad 1 remains in its compressed state due to the medium 2 holding it together, the manufacturing operation is completed and the compressed compression pad 1 can be removed.

The compressed compression pad 1 can subsequently be used in order to manufacture a battery cell module or battery, as illustrated in FIGS. 2A-2C. In FIG. 2A, a battery cell stack 5 is first constructed, which in the illustrated example comprises four battery cells 4, wherein a compressed compression pad 1 laterally abuts each battery cell 4. The battery cells 4 can be glued to the compression pads 1, for example, or surrounded by a temporarily supporting structure, such as a mesh-like sheathing. FIG. 2B illustrates the assembly step in which the battery cell stack 5 is inserted into a housing 6 in order to form the battery cell module 8 or the battery. Because the battery cell stack 5 is undersized, it can be inserted very simply into the battery stack 5 and the side walls of the housing 6, in particular without frictional forces. In the assembly phase, a gap 7 is provided between the battery cell stack 5 and the side walls of the housing 6. After the battery cell stack 5 has been inserted into the housing 6, an expansion step of the compression pads 1 is carried out. The compression pads heat up, either passively through the room temperature or actively by passing a fluid through the cooling channels 9, for example the cooling fluid of the liquid cooling system of the battery module 8. As a result of the heating, the material properties of the medium 2 change so that its retaining force decreases and the expansion forces of the compression pad 1 are superior. As a result, the compressed or pushed together compression pads 1 expand and in turn simultaneously compress the battery cells 2 within the housing 6 (the gap 7 disappears).

The operation during which the medium 2 loses its retaining force by heat so that the compressed compression pad 1 can expand to its original state can be initiated by different processes, such as by softening, melting, or resublimation.

What is claimed:

1. A compression pad having a shape memory function for a battery cell stack, said compression pad comprising:
an internal space containing a filler material and a medium,
wherein, due to a strength of the medium, the medium holds the compression pad in a compressed shape as compared to a shape that the compression pad would take without the medium.

2. The compression pad according to claim 1, wherein the filler material is elastic.

3. The compression pad according to claim 1, wherein the medium comprises a cooling medium of a liquid cooling system of a battery.

4. The compression pad according to claim 1, wherein the medium is machined into the filler material.

5. A method for manufacturing a compression pad having a shape memory function for a battery cell stack, said method comprising:
introducing a medium into a compression pad;
compressing the compression pad filled with the medium; and
cooling the compressed compression pad to a temperature which causes the cooled medium to hold the compression pad in a compressed shape when no external forces are acting thereupon.

6. The method according to claim 5, wherein the medium comprises a cooling medium of a liquid cooling system of a battery.

7. The method according to claim 5, wherein the medium is an additive which is machined into an interior of the compression pad.

8. The method according to claim 5, wherein the temperature is below an operating temperature of the battery cell stack.

9. A method for manufacturing a battery cell module, said method comprising:
performing the compression pad manufacturing method of claim 5;
arranging the cooled compression pad between two battery cells of a battery cell package; and
inserting the battery cell package into a housing, wherein the battery cell package is undersized with respect to a design space provided for the battery cell package in the housing.

10. The method according to claim 9, further comprising heating the compression pad to a temperature that causes the medium to no longer be able to hold the compression pad in the compressed shape.

11. The method according to claim 9, wherein the heating of the compression pad is caused by a fluid flowing through the battery cell module.
